(19) United States
(12) Patent Application Publication
(10) Pub. No.: US 2014/0061228 A1
(43) Pub. Date: Mar. 6, 2014

(54) GOODS DELIVERY MECHANISM FOR VENDING MACHINE

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventors: YUN-LUNG CHEN, New Taipei (TW); CHUNG CHAI, New Taipei (TW); DA-LONG SUN, Wuhan (CN); YU-GUI CHEN, Wuhan (CN); NIAN-YUAN YANG, Wuhan (CN)

(21) Appl. No.: 13/909,228

(22) Filed: Jun. 4, 2013

(30) Foreign Application Priority Data
Sep. 3, 2012 (CN) 2012103210178

(51) Int. Cl. G07F 11/42

(52) U.S. Cl. CPC G07F 11/42
USPC 221/277

(57) ABSTRACT

A goods delivery assembly for a vending machine includes a rotatable shaft, a shell movably mounted on the shaft, and a transmitting member mounted in the shell. A hard coil is mounted on the shell. The transmitting member is engaged with the rotatable shaft. The shaft rotates in a first direction to rotate the shell for the delivery of goods and, to allow for wear and the accumulation of errors in the starting position, configured to rotate in a second direction with respect to the shell to cancel the effects of wear and any accumulated positioning errors.

### BACKGROUND

1. Technical Field

The present disclosure relates to goods delivery mechanisms, and particularly to a goods delivery mechanism in an automatic vending machine.

2. Description of Related Art

In an automatic vending machine, a delivery assembly is used for pushing goods out of a goods channel. The delivery assembly includes a large helical rigid coil and a motor. The goods are placed on the rigid coil. The motor rotates the rigid coil, to move the goods out of the goods channel. After long usage, mis-alignments of the rigid coil may become too large for the rigid coil to move goods with precision.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of a goods delivery assembly.

FIG. 2 is an enlarged view of encircled portion II of FIG. 1.

FIG. 3 is an isometric view of a shell and a cover of FIG. 1.

FIG. 4 is similar to FIG. 3, but viewed from another aspect.

FIG. 5 is a partly assembled view of the goods delivery assembly of FIG. 1.

FIG. 6 is an assembled view of the goods delivery assembly of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

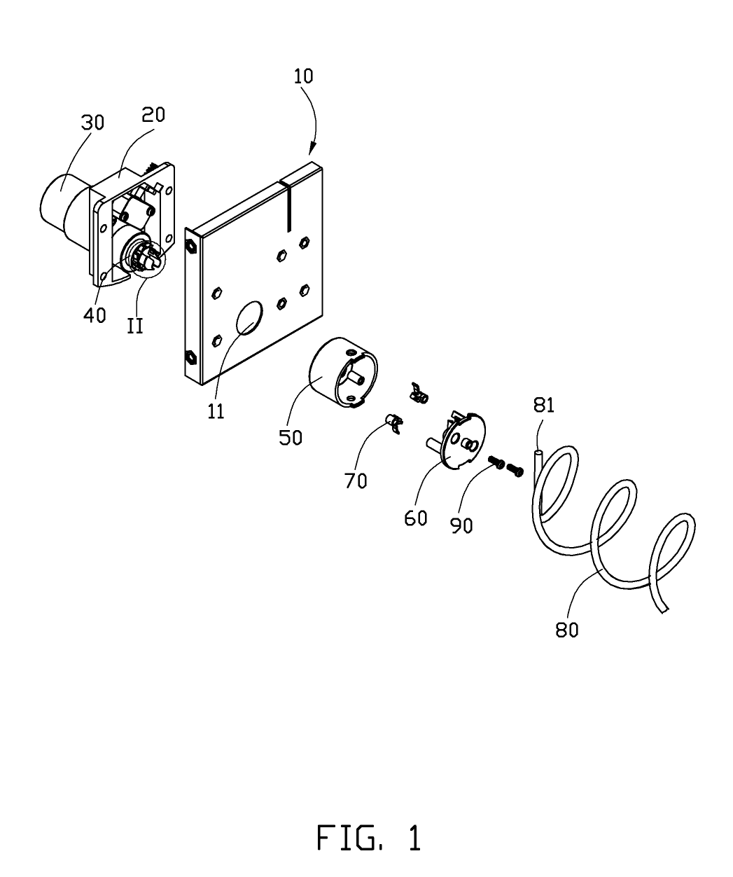

Referring to FIGS. 1 to 3, an embodiment of a goods delivery assembly for a vending machine includes a plate 10, a casing 20, a motor 30, a shaft 40, a shell 50, a cover 60, two transmitting members 70, and a hard coil 80 for receiving goods thereon.

The plate 10 defines a through hole 11.

The motor 30 is mounted in the casing 20. The shaft 40 is mounted on the motor 30. The shaft 40 is rotated by the motor 30.

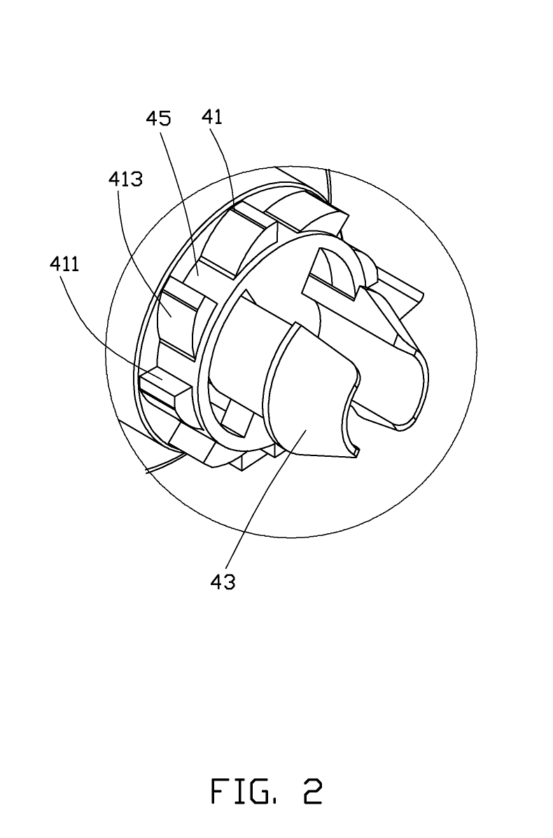

Referring to FIG. 2, a plurality of saw-tooth or freewheel teeth 41 is located on a periphery of the shaft 40. A receiving recess 45 is defined between two adjacent teeth 41. Each tooth 41 includes a pushing surface 411 and a guiding surface 413. The pushing surface 411 extends in a radial direction of the shaft 40. The guiding surface 413 is an arc surface. One end of the guiding surface 413 is connected to a free end of the pushing surface 411, and another end of the guiding surface 413 is aslant connected to the shaft 40. A pair of outwardly-stepped protruding clasps 43 protrudes from a front end of the shaft 40. The pair of clasps 43 can be elastically deformed.

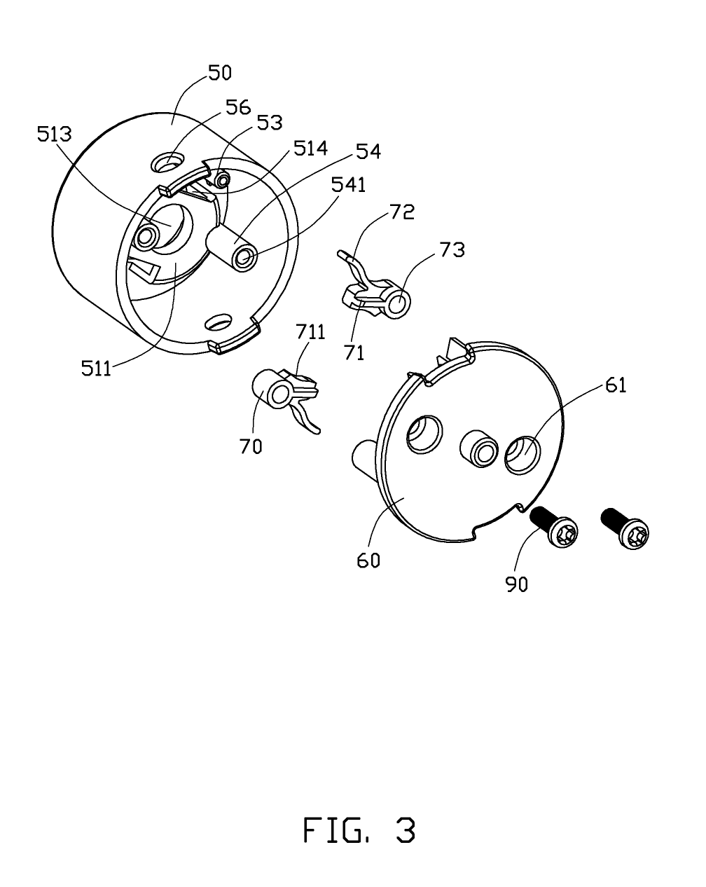

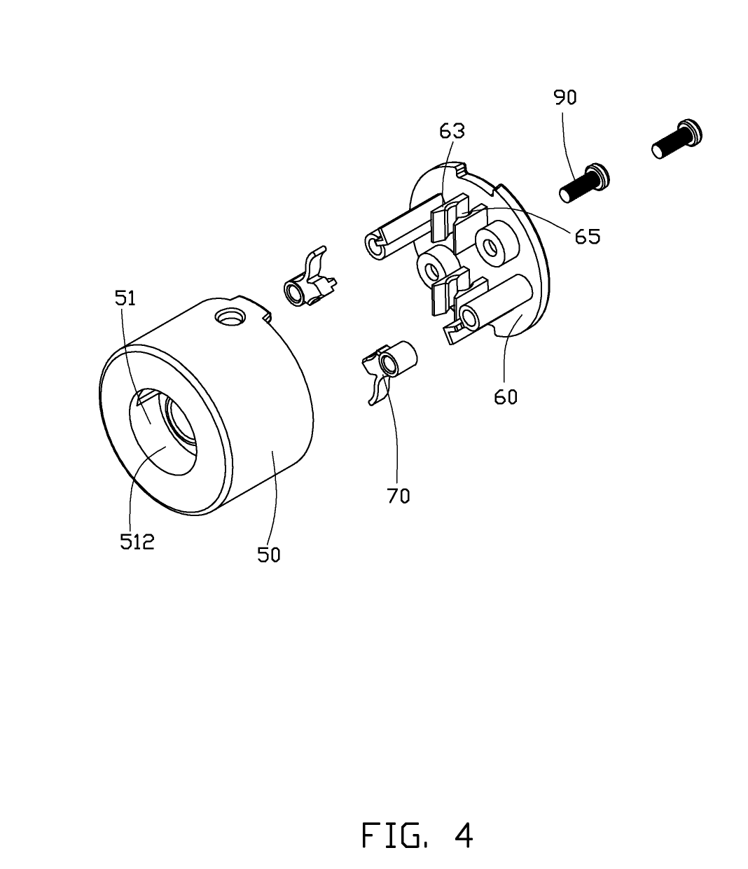

Referring to FIGS. 3 and 4, a receiving room 51 is defined on a side of the shell 50 which faces the shaft 40. The receiving room 51 is surrounded by a bottom wall 511 and a side wall 512. A center portion of the bottom wall 511 defines an engaging hole 513. A pair of cutouts 514 is symmetrically defined on the bottom wall 511. A pair of inserting pins 53 protrudes from the bottom wall 511 away from the shaft 40. Each of the pair of inserting pins 53 is located adjacent to one of the pair of cutouts 514. A pair of securing posts 54 is formed in the shell 50. Each of the pair of the securing posts 54 defines a securing hole 541. A pair of radial mounting holes 56 is symmetrically defined on a periphery of the shell 50.

The cover 60 defines a pair of through holes 61 corresponding to the pair of securing posts 54 of the shell 50. A side of the cover 60 which faces the shell 50 includes two pairs of restricting pieces 63. A groove 65 is defined between the two pairs of restricting pieces 63.

The transmitting member 70 includes a transmitting block 71 and an abutting piece 72. The abutting piece 72 includes an arc engaging surface 711. The abutting piece 72 can be elastically deformed. The transmitting member 70 defines a fixing hole 73 corresponding to the inserting pin 53 of the shell 50.

The hard coil 80 includes an inserting portion 81.

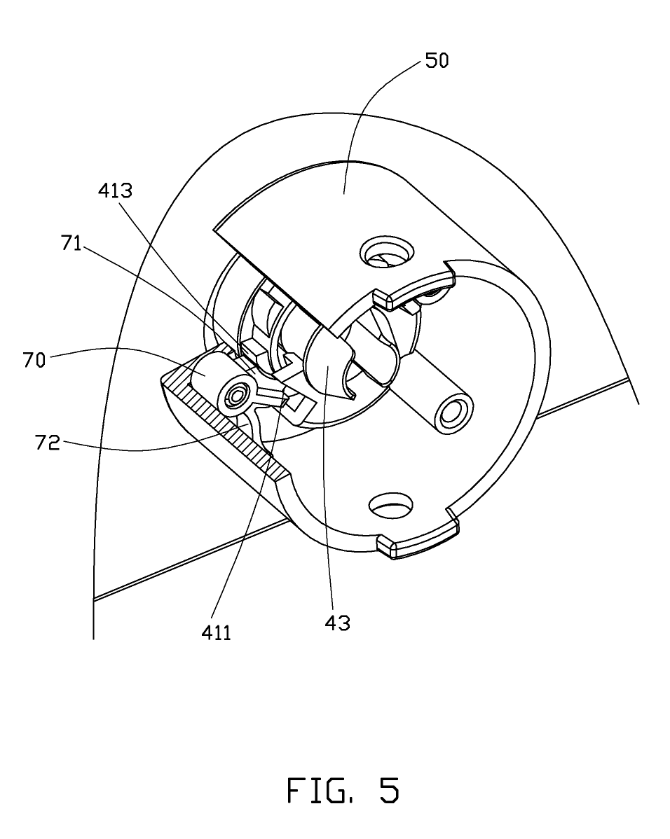

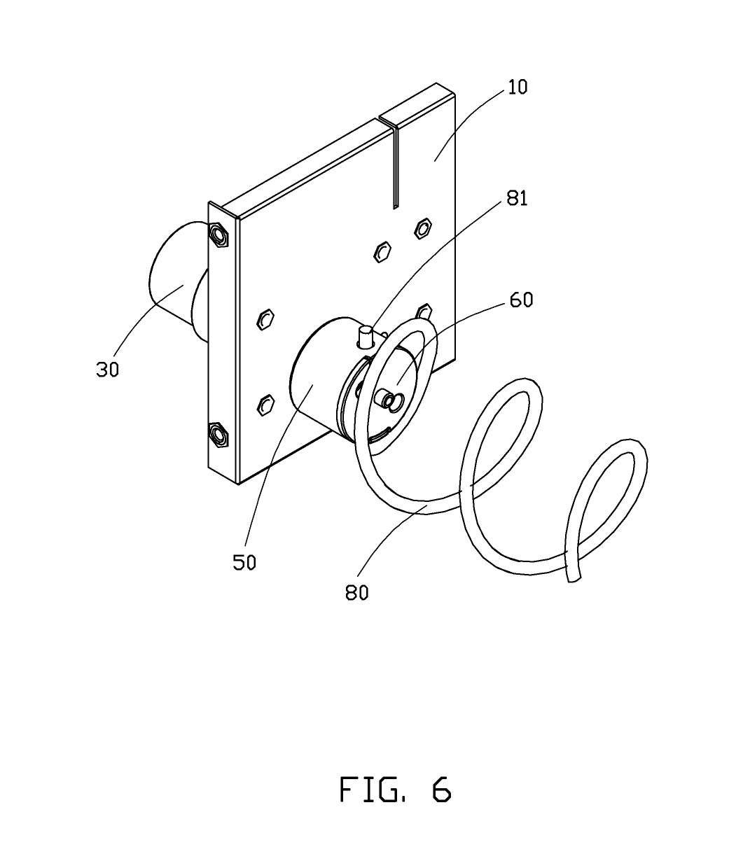

Referring to FIGS. 1 to 6, in assembly, the inserting pin 53 of the shell 50 is inserted in the fixing hole 73. The transmitting block 71 extends through the cutout 514 to be located in the receiving room 51. The abutting piece 72 abuts an inner side of the shell 50 to secure the transmitting member 70 in the shell 50.

The casing 20 is secured on the plate 10 with the shaft 40 inserted in the through hole 11. The pair of clasps 43 is elastically deformed to be inserted to the engaging hole 513. Then, the pair of clasps 43 rebound to have the clasps 43 latch on edges of the engaging hole 513. Simultaneously, the teeth 41 of the shaft 40 are received in the receiving room 51 of the shell 50. The transmitting block 71 of the transmitting member 70 is received in a receiving recess 45 of the shaft 40. The pushing surface 411 of a tooth 41 abuts the transmitting block 71. The engaging surface 711 of the transmitting block 71 is placed on the guiding surface 412 of another tooth 41. When the motor 30 drives the shaft 40 to rotate in a first direction (in one embodiment, the first direction is clockwise), the pushing surface of the tooth 41 pushes the transmitting block 71 to rotate the shell 50 together with the shaft 40. When the motor 30 drives the shaft 40 to rotate in a second direction (in one embodiment, the second direction is anti-clockwise), the pushing surface 411 of the tooth 41 does not push the transmitting block 71, the guiding surface 413 of the tooth 41 instead slides over the engaging surface 711, and the shell 50 is not rotated together with the shaft 40.

The inserting portion 81 of the hard coil 80 is inserted in the mounting holes 56 of the shell 50 to mount the hard coil 80 on the shell 50. The through holes 61 of the cover 60 are aligned to the securing holes 541 of the shell 50. Two fasteners 90 are inserted in the through holes 61 and the securing holes 541 to mount the cover 60 on the shell 50. At this position, the inserting portion 81 of the hard coil 70 is located in the groove 65 of the cover 60. Thereby, the goods delivery assembly is assembled.

When the motor 30 rotates in the first direction, the hard coil 80 is rotated by the shaft 40 to deliver goods. After the goods delivery assembly has been used for a long time and a cumulative error angle of the rigid coil develops and becomes large, the motor 30 rotates in the second direction to reposition the shell 50 and the hard coil 80 with respect to the shaft 40.

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A goods delivery assembly, comprising:
a shaft adapted to rotate;
a plurality of teeth formed on a peripheral of the shaft, each of the plurality of teeth comprising a pushing surface and a guiding surface;
a shell mounted on the shaft, a hard coil secured on the shell; and
a transmitting member mounted in the shell, the transmitting member comprising a transmitting block which comprises an engaging surface;
wherein the transmitting block is abutted by the pushing surface of a tooth of the plurality of teeth with the engaging surface joints with the guiding surface of another tooth of the plurality of teeth, wherein the shaft is configured to rotate in a first direction to have the pushing surface pushing the transmitting block to rotate the shell and the hard coil, and the shaft is configured to rotate in a second direction to have the guiding surface sliding over the engaging surface to locate the shell in a different position with respect to the shaft.

2. The goods delivery assembly of claim 1, wherein a receiving recess is defined between two adjacent teeth of the plurality of teeth, and the transmitting block is received in the receiving recess.

3. The goods delivery assembly of claim 1, wherein the pushing surface extends in a radial direction of the shaft, one end of the guiding surface is connected to a free end of the pushing surface, and another end of the guiding surface is aslant connected to the shaft.

4. The goods delivery assembly of claim 1, wherein a receiving room is defined on a side of the shell which faces to the shaft, the receiving room is surrounded by a bottom wall and a side wall, a cutout is defined on the bottom wall, the plurality of teeth of the shaft is received in the receiving room, and the transmitting block extends through the cutout to be located in the receiving room.

5. The goods delivery assembly of claim 4, wherein the bottom wall defines an engaging hole, the shaft comprises a pair of departed clasps, and the pair of departed clasps are configured to be elastically deformed to clasp edges of the engaging hole.

6. The goods delivery assembly of claim 1, wherein the transmitting member comprises an abutting piece and a fixing hole, the shell comprises an inserting pin, the inserting pin is inserted in the fixing hole, and the abutting piece abuts an inner side of the shell.

7. The goods delivery assembly of claim 1, wherein a pair of radial mounting holes is symmetrically defined on a periphery of the shell, the hard coil comprises an inserting portion, and the inserting portion is inserted into the pair of radial mounting holes.

8. The goods delivery assembly of claim 7, wherein a cover is mounted on the shell, the cover comprises a pair of restricting pieces, and the inserting portion is restricted between the pair of restricting pieces.

9. A goods delivery assembly, comprising:
a shaft which is rotatable;
a shell movably mounted on the shaft, a hard coil mounted on the shell at a mounting angle; and
a transmitting member mounted in the shell,
wherein the transmitting member is engaged with the shaft in such a manner that the shaft is configured to bring the shell rotating when the transmitting member rotates in a first direction, and the shaft is configured to rotate with respect to the shell in a second direction to adjust the mounting angle of the hard coil.

10. The goods delivery assembly of claim 9, wherein a plurality of teeth is formed on a peripheral of the shaft, each of the plurality of teeth comprises a pushing surface and a guiding surface; the transmitting member comprises a transmitting block which comprises an engaging surface; the transmitting block is abutted by the pushing surface of an tooth of the plurality of teeth with the engaging surface jointing with the guiding surface of another tooth of the plurality of teeth, the shaft is configured to rotate in the first direction to have the pushing surface pushing the transmitting block to rotate the shell and the hard coil, and the shaft is configured to rotate in the second direction to have the guiding surface sliding over the engaging surface to locate the shell in a different position with respect to the shaft.

11. The goods delivery assembly of claim 10, wherein a receiving recess is defined between two adjacent teeth of the plurality of teeth, and the transmitting block is received in the receiving recess.

12. The goods delivery assembly of claim 10, wherein the pushing surface extends in a radial direction of the shaft, one end of the guiding surface is connected to a free end of the pushing surface, and another end of the guiding surface is aslant connected to the shaft.

13. The goods delivery assembly of claim 10, wherein a receiving room is defined on a side of the shell which faces to the shaft, the receiving room is surrounded by a bottom wall and a side wall, a cutout is defined on the bottom wall, the plurality of teeth of the shaft is received in the receiving room, and the transmitting block extends through the cutout to be located in the receiving room.

14. The goods delivery assembly of claim 13, wherein the bottom wall defines an engaging hole, the shaft comprises a pair of departed clasps, and the pair of departed clasps are configured to be elastically deformed to clasp edges of the engaging hole.

15. The goods delivery assembly of claim 10, wherein the transmitting member comprises an abutting piece and a fixing hole, the shell comprises an inserting pin, the inserting pin is inserted into the fixing hole, and the abutting piece abuts an inner side of the shell.

16. The goods delivery assembly of claim 10, wherein a pair of radial mounting holes is symmetrically defined on a periphery of the shell, the hard coil comprises an inserting portion, and the inserting portion is inserted into the pair of radial mounting holes.

17. The goods delivery assembly of claim 16, wherein a cover is mounted on the shell, the cover comprises a pair of restricting pieces, and the inserting portion is restricted between the pair of restricting pieces.
